(19) United States
(12) Patent Application Publication
(10) Pub. No.: US 2015/0356744 A1
(43) Pub. Date: Dec. 10, 2015

(54) METHOD AND APPARATUS FOR SENSING MOVING BALL, AND IMAGE PROCESSING METHOD OF BALL IMAGE FOR CALCULATION OF SPIN OF MOVING BALL

(71) Applicant: GOLFZON CO., LTD., YUSEONG-GU Daejeon (KR)

(72) Inventor: Sang Hyun JOO, Daejeon (KR)

(21) Appl. No.: 14/759,653

(22) PCT Filed: Jan. 8, 2014
(86) PCT No.: PCT/KR2014/000197

§ 371 Date: Jul. 8, 2015

(30) Foreign Application Priority Data
Jan. 8, 2013 (KR) 10-2013-0002202

(51) Int. Cl. G06T 7/20; G06K 9/40; G06K 9/46

(52) U.S. Cl. CPC G06T 7/2033; G06K 9/46; G06K 9/40; G06T 2207/10016; G06T 2207/30224

(57) ABSTRACT

Disclosed is measurement of spin by acquiring an image of a moving ball according to hit and analyzing the image, and more particularly, disclosed are a method and apparatus for sensing a moving ball, and an image processing method of a ball image, for measuring spin of the moving ball by rapidly and accurately extracting an unspecified indication such as a logo of a ball manufacturer, a trademark of the ball, a scratch, stain, etc. pre-indicated on the ball, that is, a feature portion in a simple manner, instead of indicating a specific pattern for spin measurement only, and then accurately calculating spin axis and spin amount information of rotation of the ball based on the feature portion.

### TECHNICAL FIELD

The present invention relates to a method and apparatus for sensing a moving ball, and an image processing method of a ball image for calculation of spin of a moving ball, for acquiring an image of the moving ball and processing and analyzing the image to calculate the spin of the ball.

### BACKGROUND ART

With regard to sports games, specifically, golf, attempts have always been made to accurately sense the physical characteristics of a moving ball that is hit by a golfer, to analyze the hit ball or to realize the hit ball in the form of an image using the sensed value, and to apply the result to simulated golf such as so-called screen golf.

In particular, when a ball is hit to fly, the ball rotates at very high speed with respect to an axis in a three-dimensional (3D) space, and thus, it is very difficult to measure spin of the ball and very expensive equipment is required to accurately measure the spin of the ball.

A representative method for measuring spin of a ball includes a method using a radar sensor or a method of analyzing a captured image using a high speed or ultrahigh speed camera. Among these methods, the method of calculating spin of the moving ball using the high speed or ultrahigh speed camera is performed by calculating a spin axis and spin amount of the moving ball by indicating a specific pattern on the ball and analyzing a change in the specific pattern indicated on the ball on images captured by the high speed or ultrahigh speed camera. Here, the specific pattern is a simple shape and indicated on the ball using specific size and color or a photosensitive material, and thus, spin calculation is performed while the specific pattern is clearly differentiated in an image.

However, according to the method of indicating the specific pattern on the ball and analyzing an image of the pattern, it is inconvenient and cumbersome to indicate a specific pattern on each ball and it may be impossible to measure the spin of the ball as the pattern indicated on the ball becomes faint or is partially removed due to repeated measurement.

### DISCLOSURE

### Technical Problem

Therefore, the present invention has been made in view of the above problems, and it is an object of the present invention to provide measurement of spin by acquiring an image of a moving ball according to hit and analyzing the image, and more particularly, a method and apparatus for sensing a moving ball, and an image processing method of a ball image, for measuring spin of the moving ball by rapidly and accurately extracting an unspecified indication such as a logo of a ball manufacturer, a trademark of the ball, a scratch, stain, etc. pre-indicated on the ball, that is, a feature portion in a simple manner, instead of indicating a specific pattern for spin measurement only, and then accurately calculating spin axis and spin amount information of rotation of the ball based on the feature portion.

### Technical Solution

In accordance with an aspect of the present invention, the above and other objects can be accomplished by the provision of an apparatus for sensing a moving ball, for acquiring and analyzing an image of the moving ball to calculate spin of the moving ball, the apparatus including an image acquisition unit for acquiring consecutive images according to movement of a ball with a surface having a predetermined feature portion indicated thereon, an image processing unit for extracting a ball image as an image corresponding to a ball portion from each image acquired by the image acquisition unit and removing a dimple portion and various noise portions from the ball image to extract the feature portion from the ball image, and a spin calculation unit for calculating a spin axis and spin amount of the ball by analyzing a position change in feature portions respectively extracted from two consecutive ball images.

In accordance with another aspect of the present invention, there is provided a method of sensing a moving ball, for acquiring and analyzing an image of the moving ball to calculate spin of the moving ball, the method including acquiring consecutive images according to movement of a ball with a surface having a predetermined feature portion indicated thereon, extracting a ball image as an image corresponding to a ball portion from each of the acquired images, removing a dimple portion and various noise portions from the ball image to extract the feature portion from the ball image, and calculating a spin axis and spin amount of the ball by analyzing a position change in feature portions respectively extracted from two consecutive ball images.

In accordance with another aspect of the present invention, there is provided an image processing method of a ball image extracted from an image, for acquiring the image of movement of a ball with a surface having a predetermined feature portion indicated thereon and calculating spin of the ball based on the feature portion, the method including rotating a ball on the ball image as an original image by an arbitrary angle, extracting an n-th differential image obtained by subtracting the original image from the image, the ball of which is rotated, extracting an n-th accumulated image by accumulating the n-th differential image on an (n−1)th differential image or an (n−1)th accumulated image, and binarizing the n-th accumulated image according to a predetermined reference value to extract a feature portion from an image, where n is a natural number equal to or greater than 2.

### Advantageous Effects

A method and apparatus for sensing a moving ball, and an image processing method of a ball image according to the present invention measure spin by acquiring an image of a moving ball according to hit and analyzing the image, and more particularly, measures spin of the moving ball by rapidly and accurately extracting an unspecified indication such as a logo of a ball manufacturer, a trademark of the ball, a scratch, stain, etc. pre-indicated on the ball, that is, a feature portion in a simple manner, instead of indicating a specific pattern for spin measurement only, and then accurately calculating spin axis and spin amount information of rotation of the ball based on the feature portion.

### DESCRIPTION OF DRAWINGS

The above and other objects, features and other advantages of the present invention will be more clearly understood from the following detailed description taken in conjunction with the accompanying drawings, in which:

FIG. 1 is a schematic block diagram illustrating a structure of an apparatus for sensing a moving ball according to an embodiment of the present invention;

FIG. 2 is a diagram for explanation of functions of components from image acquisition to calculation of spin of a ball using components illustrated in FIG. 1;

FIGS. 3(a) to 3(c) are diagrams respectively illustrating source images of consecutively acquired images;

FIG. 4 is a diagram obtained by enlarging a ball portion of FIG. 3(a);

FIGS. 5(a) to 5(c) are diagrams for explanation of a process for extracting a ball portion from each of the source images illustrated in FIGS. 3(a) to 3(c);

FIGS. 6(a) to 6(c) are diagrams respectively illustrating normalized images of extracted ball images illustrated in FIGS. 5(a) to 5(c);

FIGS. 7(a) to 7(f) are diagrams of a time-series process of extracting a ball feature potion from the image illustrated in FIG. 6(a);

FIG. 8 is a diagram for explanation of calculation of spin of a moving ball; and

FIGS. 9(a) and 9(b) illustrate images obtained by normalizing ball images extracted from two consecutive source images, and FIGS. 9(c) and 9(d) illustrate feature portion images obtained by respectively extracting featuring portions from the images illustrated in FIGS. 9(a) and 9(b).

### BEST MODE

Hereinafter, exemplary embodiments of a method and apparatus for sensing a moving ball, and an image processing method of a ball image for calculation of spin of a moving ball according to the present invention will be described in detail with reference to the accompanying drawings.

The present invention may be basically configured to photograph a golf ball (hereinafter, referred to as a “ball”), which is hit by a golf club of a user, via a predetermined camera, to analyze the captured image, and to calculate spin of the hit ball. Here, the camera may be a three-dimensional (3D) camera or a stereo camera configured by a plurality of cameras in a stereo manner and may be configured to convert coordinates of a two-dimensional (2D) image of the ball into 3D coordinates or vice versa.

In addition, the method and apparatus for sensing a moving ball, and the image processing method of a ball image for calculation of spin of a ball according to the present invention may be applied to various fields such as analysis of a hit ball according to golf swing of a user, a virtual golf using a virtual reality-based simulation, and so on.

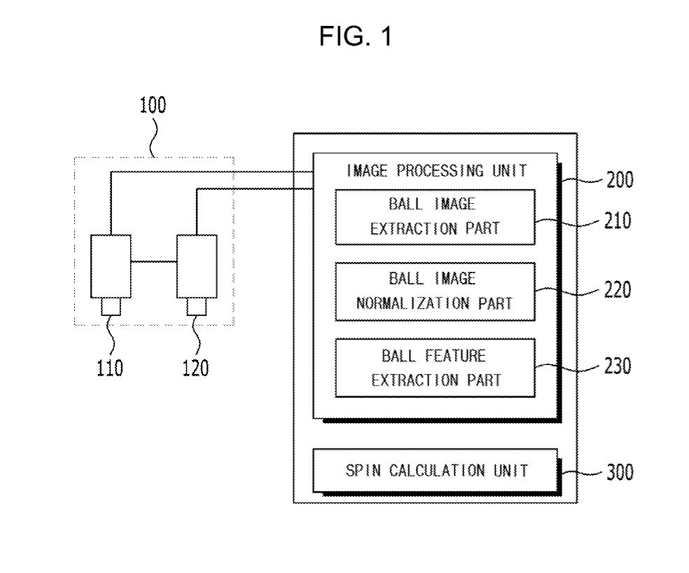

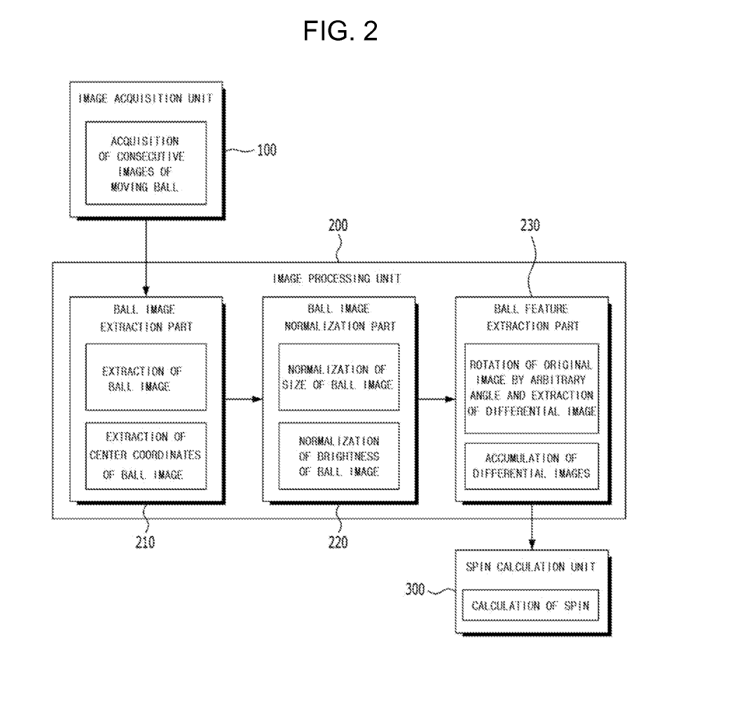

First, an apparatus for sensing a moving ball according to an embodiment of the present invention will be described with reference to FIGS. 1 and 2.

As illustrated in FIGS. 1 and 2, an apparatus for sensing a moving ball according to an embodiment of the present invention includes an image acquisition unit 100, an image processing unit 200, and a spin calculation unit 300. The image acquisition unit 100 may be a camera device and may be embodied through a 3D camera device or a stereo camera including a plurality of cameras, as described above. FIG. 1 illustrates a case in which the image acquisition unit 100 is embodied as a stereo camera device including a first camera 110 and a second camera 120.

The image processing unit 200 is a component that extracts a ball image that is an image corresponding to a ball portion from each image acquired by the image acquisition unit 100 and removing a dimple portion and various noise portions from the ball image to extract a feature portion of the ball image, that is, an unspecified indication such as a trademark or a logo indicated on the ball, a scratch, etc.

The image processing unit 200 may include a ball image extraction part 210, a ball image normalization part 220, and a ball feature extraction part 230.

The ball image extraction part 210 is configured to extract a ball image that is an image corresponding to a ball portion from a source image that is an image acquired by the image acquisition unit 100 and to extract central coordinates of the ball portion, which will be described below in detail.

The ball image normalization part 220 is configured to normalize size and brightness of the ball, which vary on the source image according to a position of the ball in space by performing a normalization process on size and brightness information of each ball image extracted by the ball image extraction part 210, which will be described below in detail.

The ball feature extraction part 230 is a component that extracts the feature portion (i.e., an unspecified indication such as a trademark or a logo indicated on the ball, a scratch, etc.) indicated on the image on which image normalization is already performed by the ball image normalization part 220 from the ball image extracted by the ball image extraction part 210. To this end, only the feature portion is extracted while an arbitrary degree rotation step, a differential image step, and an accumulation step are repeatedly performed a predetermined number of times on an original image on which image normalization is performed by the ball image normalization part 220, which will be described below in detail.

The spin calculation unit 300 is configured to analyze a position change in feature portions that are respectively extracted from two consecutive ball images to calculate a spin axis and spin amount of a ball, which will be described below in detail.

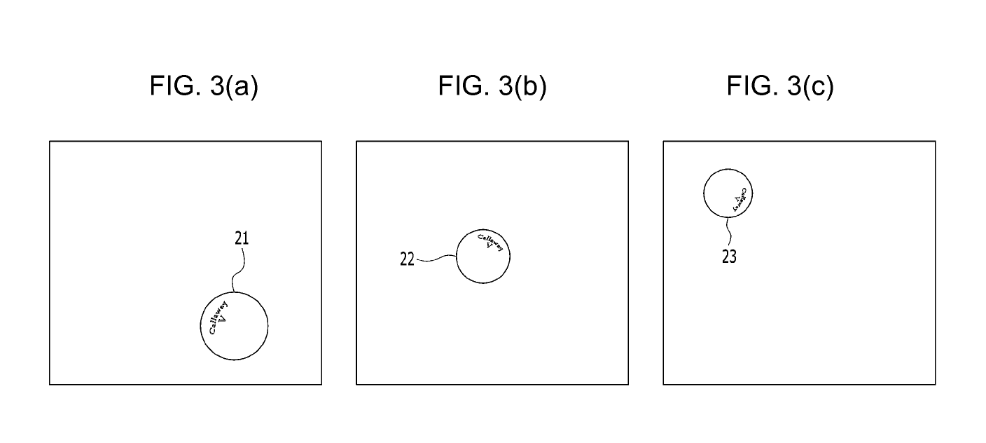

First, an example of a procedure of extracting the ball image from the source image acquired by the image acquisition unit 100 by the ball image extraction part 210 will be described in detail with reference to FIGS. 3 to 5.

FIGS. 3(a), 3(b), and 3(c) illustrate images in states in which only ball portions 21, 22, and 23 are remained by removing a background portion and so on using a differential image from images acquired by photographing a moving ball within a viewing angle via a fixed camera at a predetermined time interval.

As seen from FIGS. 3(a), 3(b), and 3(c), a current state is a state in which a ball flies in a left diagonal direction. As seen from FIGS. 3(a), 3(b), and 3(c), when the ball approaches a camera, the viewed ball is enlarged like the ball portion 21 as illustrated in FIG. 3(a), and then, as the ball gradually moves away from the camera, the viewed ball becomes smaller like the ball portions 22 and 23 as illustrated in FIGS. 3(b) and 3(c).

Here, the images illustrated in FIGS. 3(a), 3(b), and 3(c), that is, an image of a ball portion as a moving portion, remained by removing a background portion and various noise portions from an initially acquired image via a differential image, etc., is referred to as a source image.

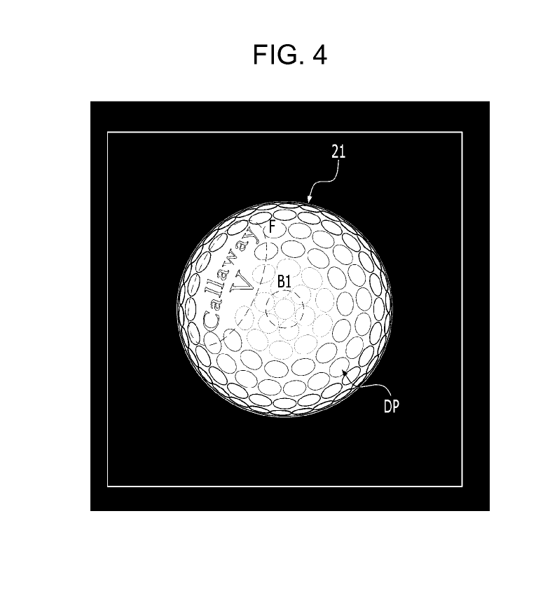

When the ball portion 21 on the source image is enlarged, the ball portion 21 may include various noises, e.g., so-called salt and pepper noise looking like partially scattered salt or pepper, fixed pattern noise generated at a fixed location, and so on as well as a dimple portion DP covering a surface of a ball and a ball feature portion F indicated on one side of the ball, and a lightest portion B1 and a darkest portion D1 appear via gradation due to influence of illumination applied to the ball, as illustrated in FIG. 4.

Here, in order to extract only a ball feature portion F, it is necessary to effectively and appropriately remove the dimple portion DP, influence of gradation, and various noises only while the ball feature portion F remains, which is performed by a ball feature extraction part, which will be described below with reference to FIG. 7.

In order to extract the ball feature portion F, it is necessary to effectively extract only images of the ball portions 21, 22, and 23, that is, only a ball image from the source image, as illustrated in FIG. 3.

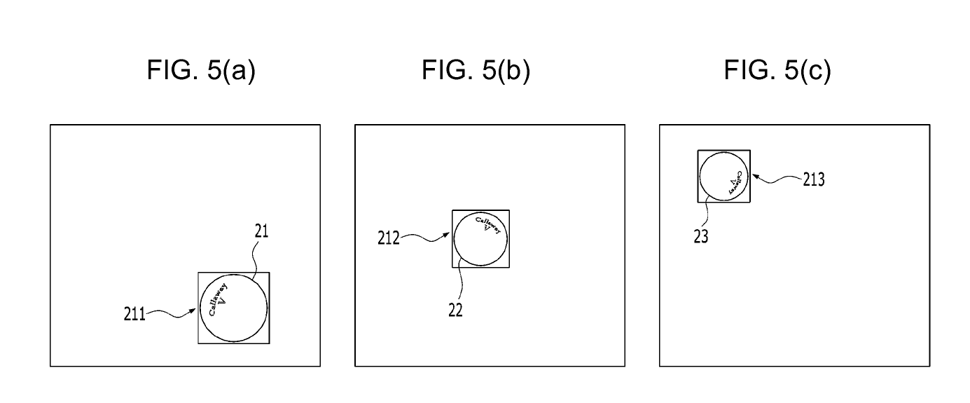

FIGS. 5(a), 5(b), and 5(c) illustrate a case in which only a ball portion is extracted from each source image. Here, the ball portions 21, 22, and 23 may be searched for and accurately extracted from source images such that a center of a ball portion is a center of an extracted ball image and an outline of the ball portion substantially corresponds to an outline of the extracted image.

Images obtained by extracting only the ball portions 21, 22, and 23 from the respective source images, that is, ball images 211, 212, and 213 have sizes corresponding to ball portions on the respective source images and thus have different sizes. The ball portions 21, 22, and 23 indicated on the respective source images are differently affected by illumination according to a distance from a camera and thus brightness also varies for each respective ball image.

In order to accurately extract a ball feature portion, it is necessary to equalize the sizes of the ball images 211, 212, and 213 and normalize the brightness of the ball images 211, 212, and 213.

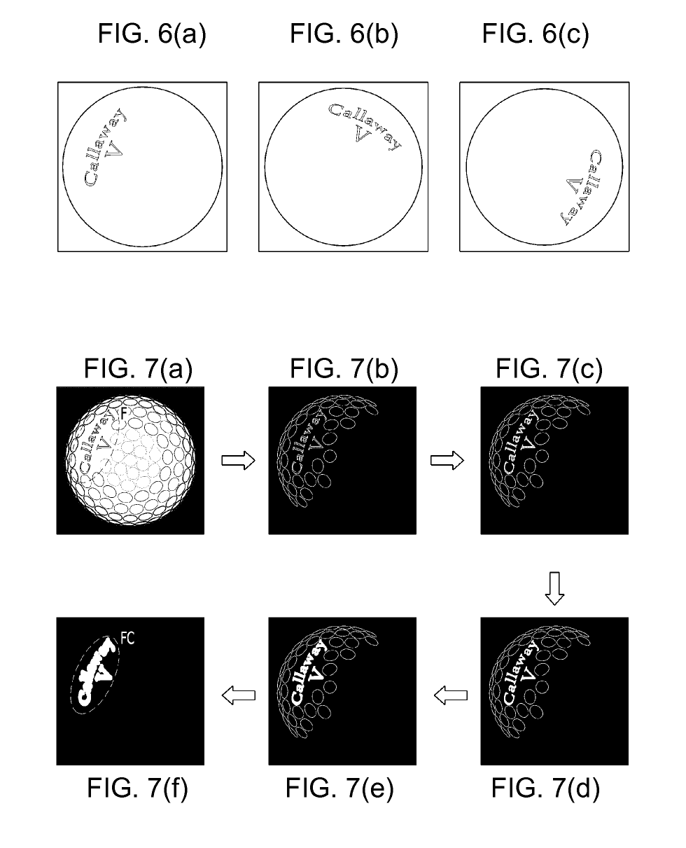

FIGS. 6(a), 6(b), and 6(c) illustrate images containing ball images corresponding to FIGS. 5(a), 5(b), and 5(c), the size and brightness of which are normalized by a ball image normalization part.

That is, the ball images 211, 212, and 213 may be enlarged or reduced according to respective preset sizes or remaining ball images may be enlarged or reduced based on any one of the ball images 211, 212, and 213, that is, a normalization process may be performed on each ball image, thereby equalizing the sizes of ball images 211, 212, and 213.

In addition, a normalization process may be performed on each ball image using an average value of all pixels constituting a ball portion to equalize overall brightness of ball images to each other.

As described above, after normalization is completed on each ball image, an extraction process of the ball feature portion F via a ball feature extraction part is performed on each normalized ball image, as illustrated in FIG. 7.

FIG. 7(a) illustrates a normalized ball image which will be referred to as an original image. FIGS. 7(b), 7(c), 7(d), and 7(e) illustrate images obtained by sequentially accumulating differential images that are obtained by subtracting the original image from images formed by rotating a ball of the original image by an arbitrary angle. FIG. 7(f) is an image obtained by binarizing an accumulated image illustrated in FIG. 7(e).

The image illustrated in FIG. 7(b) is obtained by rotating the original image illustrated in FIG. 7(a) by a preset angle or an arbitrarily selected angle with respect to a central point of a ball and then extracting a differential image obtained by subtracting the original image from the image, the ball of which is rotated. Here, the image of FIG. 7(b) is referred to as a primary differential image. As the number of time for obtaining a differential image is increased, an order indicating the differential image is increased one by one.

In the differential image between the rotated image and the original image, a changed portion between the two images appears light and a non-changed portion between the two images appears dark, and thus, the feature portion F mainly appears light and the remaining portions appear almost dark.

Although the ball rotates, a dimple portion is almost the same before and after rotation and thus is almost a non-changed portion. Thus, the dimple portion is almost removed (dark area), and a gradation portion or various noise portions of the original image are removed.

However, a feature portion may not clearly appear via a differential image that is obtained one time. Accordingly, by extracting a differential image at another angle and accumulating the extracted differential image on the previous differential image, a light area of the image appears lighter, and thus, the feature portion appears lighter and more clearly.

FIG. 7(c) illustrates a secondary accumulated image obtained by accumulating a differential image that is obtained by subtracting the original image from an image formed by rotating a ball of the original image by a preset angle or an arbitrarily selected angle, that is, by accumulating a secondary differential image on the image illustrated in FIG. 7(b) as the primary differential image.

FIG. 7(d) illustrates a tertiary accumulated image obtained by accumulating a differential image that is obtained by subtracting the original image from an image formed by rotating a ball of the original image by a preset angle or an arbitrarily selected angle, that is, by accumulating a tertiary differential image on the image illustrated in FIG. 7(c) as the secondary accumulated image.

FIG. 7(e) illustrates a quaternary accumulated image obtained by accumulating a differential image that is obtained by subtracting the original image from an image formed by rotating a ball of the original image by a preset angle or an arbitrarily selected angle, that is, by accumulating a quaternary differential image on the image illustrated in FIG. 7(d) as the tertiary accumulated image.

As seen from the quaternary accumulated image obtained by sequentially accumulating the four differential images, that is, as seen from the image illustrated in FIG. 7(e), a feature portion appears very light and the remaining portions are almost completely removed to become an almost black area. However, dimple portions are not completely removed and partially appear.

Accordingly, in order to extract only the feature portion, the quaternary accumulated image is binarized via a threshold process or the like using a predetermined reference value to extract the image illustrated in FIG. 7(f).

The image illustrated in FIG. 7(f) is an image in which only a completely extracted feature portion FC appears and is referred to as a feature portion image.

Feature portions are respectively extracted from consecutive ball images, as described above, to prepare feature point images, and spin of the ball is calculated using the feature portion images by a spin calculation unit.

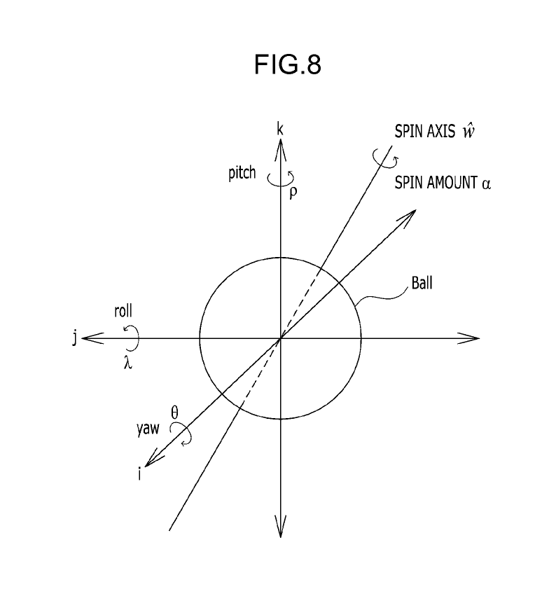

Here, the spin of the ball may be calculated by calculating coordinate information about a spin axis in 3D space based on an i-axis, j-axis, and k-axis coordinate system and an angle for rotation with respect to the spin axis, that is, information about a spin amount, as illustrated in FIG. 8.

As illustrated in FIG. 8, components for representing a rotational motion in a 3D space may include pitch, yaw, and roll. In addition, when a rotational component in an i-axis direction is θ, a rotational component in a j-axis direction is X, and a rotational component in a k-axis direction is p, a vector of target spin may be represented according to Equation 1 below.

\vec{ω}=θi+λj+ρk [Equation 1]

Based on the spin vector (ω), the spin axis information and the spin amount information may be calculated according to Equations 2 and 3 below, respectively. Here, α is the spin amount information.

$$\begin{matrix}\hat{ω} = ( \frac{θ}{α} , \frac{λ}{α} , \frac{ρ}{α} ) & [ Equation 2 ] \\ α = \sqrt{{θ}^{2} + {λ}^{2} + {ρ}^{2}} & [ Equation 3 ]\end{matrix}$$

Accordingly, the spin axis and spin amount information may be obtained by calculating θ as a yaw rotational component of spin of a moving ball, λ as a roll rotational component, and ρ as a pitch rotational component.

The spin axis and spin amount information may be obtained from a feature portion extracted from the ball image shown in FIG. 7.

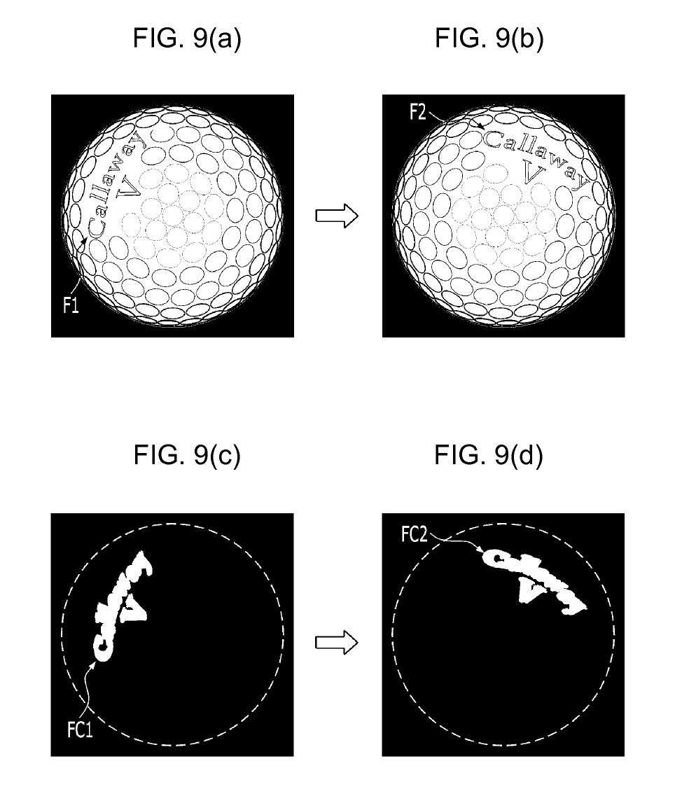

That is, as illustrated in FIG. 9, the spin axis and spin amount information may be extracted using a first feature portion image (FIG. 9(c)) and a second feature portion image (FIG. 9(d)) respectively including finally extracted feature portions FC1 and FC2 for the respective feature portions F1 and F2 on the two consecutive ball images (FIGS. 9(a) and 9(b)).

3D location information for each of pixels constituting the first feature portion image (FIG. 9(c)) may be obtained. Then, after arbitrary spin axis and spin amount information are applied to the obtained 3D location information, the result is compared with the second feature portion FC2 on the second feature portion image (FIG. 9(d)). In this case, when the result is the same or almost the same as the second feature portion FC2, the arbitrary spin axis and spin amount information is the final spin axis and spin amount information.

In this manner, arbitrary spin axis and spin amount information are repeatedly applied to the first feature portion FC1. Spin axis and spin amount information for allowing the result to be closest to the second feature portion FC2 may be selected as the final spin axis and spin amount information to calculate the spin information of the moving ball.

As described above, the present invention provides a method of rapidly and accurately extracting a feature portion of a ball portion from consecutively acquired source images in a simple manner to rapidly and accurately calculate spin of a ball based on the feature portion.

### Mode for Invention

Various embodiments have been described in the best mode for carrying out the invention.

### INDUSTRIAL APPLICABILITY

A method and apparatus for sensing a moving ball, and an image processing method of a ball image for calculation of spin of a moving ball according to the present invention is applicable to an industrial field related to golf training including analyzing a hit ball according to golf swing, a so-called screen golf industrial field providing a virtual reality-based simulation to allow a user to play a virtual golf game, and so on.

1. An apparatus for sensing a moving ball, for acquiring and analyzing an image of the moving ball to calculate spin of the moving ball, the apparatus comprising:
an image acquisition unit for acquiring consecutive images according to movement of a ball with a surface having a predetermined feature portion indicated thereon;
an image processing unit for extracting a ball image as an image corresponding to a ball portion from each image acquired by the image acquisition unit and removing a dimple portion and various noise portions from the ball image to extract the feature portion from the ball image; and
a spin calculation unit for calculating a spin axis and spin amount of the moving ball by analyzing a position change in feature portions respectively extracted from two consecutive ball images.

2. The apparatus according to claim 1, wherein the image processing unit comprises:
a ball image extraction part for extracting the ball image from a source image as the image acquired by the image acquisition unit and extracting central coordinates of the ball image; and
a ball image normalization part for normalizing size and brightness of the ball, which vary on the source image according to a position of the ball in space, by performing a normalization process on size and brightness information of the ball images extracted by the ball image extraction part, wherein the feature portion is extracted from a normalized image processed by the ball image normalization part.

3. The apparatus according to claim 1, wherein the image processing unit comprises a ball feature extraction part for extracting a feature portion from the ball image by rotating a ball on the ball image by a preset angle, extracting a differential image of an image obtained by rotating the ball on the ball image by the preset angle with respect to an original image prior to rotation of the rotated image, repeatedly performing rotation and extraction of a differential image a preset number of times, and accumulating differential images.

4. The apparatus according to claim 1, wherein the image processing unit comprises:
a ball image extraction part for extracting the ball image from a source image as the image acquired by the image acquisition unit and extracting central coordinates of the ball image;
a ball image normalization part for normalizing size and brightness of the ball, which vary on the source image according to a position of the ball in space, by performing a normalization process on size and brightness information of ball images respectively extracted from consecutive source images; and
a ball feature extraction part for extracting a feature portion from the ball image by rotating a ball on an image normalized by the ball image normalization part, as an original image, by a preset angle, extracting a differential image of the rotated image with respect to the original image, repeatedly performing rotation and extraction of the differential image a preset number of times, and accumulating differential images.

5. A method of sensing a moving ball, for acquiring and analyzing an image of the moving ball to calculate spin of the moving ball, the method comprising:
acquiring consecutive images according to movement of a ball with a surface having a predetermined feature portion indicated thereon;
extracting a ball image as an image corresponding to a ball portion from each of the acquired images;
removing a dimple portion and various noise portions from the ball image to extract the feature portion from the ball image; and
calculating a spin axis and spin amount of the ball by analyzing a position change in feature portions respectively extracted from two consecutive ball images to calculate a spin axis and spin amount of the ball.

6. The method according to claim 5, wherein the extracting of the ball image comprises:
searching for a ball portion from a source image as the image acquired by the acquiring of the images; and
extracting the ball portion such that a center of the ball portion is a center of an image to prepare the ball image.

7. The method according to claim 5, wherein the extracting of the feature portion from the ball image comprises:
normalizing a size of the ball, which varies on the source image according to a position of the ball in space, by performing a normalization process on the size of ball images respectively extracted from consecutive source images; and
extracting a feature portion from each ball image, ball size of which is normalized.

8. The method according to claim 5, wherein the extracting of the feature portion from the ball image comprises:
calculating an average value of pixel values of pixels of the extracted ball image and performing a normalization process based on the average value to normalize brightness of the ball; and
extracting a feature portion from the ball image, ball brightness of which is normalized.

9. The method according to claim 5, wherein the extracting of the feature portion from the ball image comprises:
rotating a ball on the extracted ball image as an original image by a preset angle; and
extracting a differential image of the image obtained by rotating the ball with respect to the original image to extract the feature portion from the original image.

10. The method according to claim 5, wherein the extracting of the feature portion from the ball image comprises:
extracting a primary differential image by rotating a ball on the extracted ball image as an original image by a preset angle or an arbitrarily selected angle and subtracting the original image from the rotated image;
extracting an accumulated image by rotating the ball on the original image by a preset angle or an arbitrarily selected angle, extracting a secondary differential image obtained by subtracting the original image from the rotated image, and accumulating the secondary differential image on the primary differential image; and
extracting a feature portion from the accumulated image.

11. The method according to claim 5, wherein the extracting of the feature portion from the ball image comprises:
rotating a ball on the extracted ball image as an original image by an arbitrary angle;
extracting an n-th differential image obtained by subtracting the original image from the image, the ball of which is rotated;
extracting an n-th accumulated image by accumulating the n-th differential image on an (n-1)th accumulated image; and
extracting a feature portion from the n-th accumulated image, where n is a natural number equal to or greater than 2.

12. The method according to claim 11, wherein the extracting of the feature portion from the ball image comprises binarizing the n-th accumulated image according to a predetermined reference value.

13. An image processing method of a ball image extracted from an image, for acquiring the image of movement of a ball with a surface having a predetermined feature portion indicated thereon and calculating spin of the ball based on the feature portion, the method comprising:
rotating a ball on the ball image as an original image by an arbitrary angle;
extracting an n-th differential image obtained by subtracting the original image from the image, the ball of which is rotated;
extracting an n-th accumulated image by accumulating the n-th differential image on an (n−1)th differential image or an (n−1)th accumulated image; and
binarizing the n-th accumulated image according to a predetermined reference value to extract a feature portion from an image, where n is a natural number equal to or greater than 2.
